(19) United States
(12) Patent Application Publication
(10) Pub. No.: US 2011/0003567 A1
(43) Pub. Date: Jan. 6, 2011

(54) METHOD OF EFFICIENT POWER BOOSTING

(76) Inventors: Moon Il Lee, Gyeonggi-do (KR); Hyun Soo Ko, Seoul (KR); Jae Hoon Chung, Gyeonggi-do (KR); Seung Hee Han, Gyeonggi (KR)

Correspondence Address: LEE, HONG, DEGERMAN, KANG & WAIMEY, 660 S. FIGUEROA STREET, Suite 2300, LOS ANGELES, CA, 90017, US

(21) Appl. No.: 12/920,068

(22) PCT Filed: Feb. 27, 2009
(86) PCT No.: PCT/KR09/00958

§ 371 Date: Aug. 27, 2010

Related U.S. Application Data
(60) Provisional application No. 61/032,437, filed on Feb. 29, 2008.

(30) Foreign Application Priority Data
Jul. 28, 2008 (KR) 10-2008-0073516

(51) Int. Cl. H04B 1/04

(52) U.S. Cl. 455/127.1

(57) ABSTRACT

An efficient power boosting method is provided. In the method, a first resource element for boosting power, a second resource element for achieving synchronization with a specific channel, and a third resource element for transmitting data are allocated to a predetermined resource region. Then, power of at least one of the second resource element and the third resource element is boosted using power allocated to the first resource element and information is transmitted using the predetermined resource region.

### TECHNICAL FIELD

The present invention relates to a wireless access system.

### BACKGROUND ART

The following is a brief description of a pilot symbol and a pilot channel that are generally used.

The pilot symbol is a spread spectrum signal that has not been modulated. The pilot symbol is an initial system operation signal of Mobile Stations (MSs) (mobile terminals or User Equipments (UEs)) that operate in a cell area of a base station (or Node-B). The pilot symbol can be used to achieve phase, frequency, or time synchronization of signals of a base station and can be used for channel estimation in downlink and uplink. Mobile stations constantly monitor pilot symbols and the size of the cell area may vary according to the level of the transmitted pilot symbol.

It is preferable that power of the pilot symbol be maintained at a high level since the MS uses the pilot symbol to achieve carrier phase synchronization for demodulation of another channel signal. However, when the ratio of the pilot symbol power is high, interference may occur between adjacent cells in multi-cell environments. Accordingly, it is important to use the pilot symbol while maintaining an appropriate power level thereof. Base stations in multi-cell environments use different types of pilot symbol structures and codes, thereby minimizing interference therebetween and allowing mobile stations to discriminate the base stations.

The following is a brief description of channels that can be used in a wireless access system. Channels used in the forward link include a pilot channel, a synchronous channel, a paging channel, and a traffic channel. Channels used in the backward link include an access channel and a traffic channel. Channels are discriminated using Walsh codes in the forward link and are discriminated using long codes in the backward link.

The pilot channel is used to allow the mobile station to achieve carrier phase synchronization with the base station and to acquire base station information (for example, radio channel information) and transmits signals predefined by the base or mobile stations.

The pilot channel is provided for each base station or sector. The base station periodically and constantly transmits pilot signals and the mobile station also transmits pilot signals at specific time intervals. Pilot signals can be used in a different format depending on the system. For example, pilot signals can be used in a Walsh code format. By using the predefined Walsh codes for the pilot channel, the mobile station can obtain channel information using the pilot symbol.

### DISCLOSURE

### [Technical Problem]

An object of the present invention devised to solve problems in the conventional technologies described above lies on providing a method for efficiently boosting pilot power.

Another object of the present invention lies on providing a method for flexibly changing the power level of a pilot symbol to efficiently use cell coverage and transmission power.

Another object of the present invention lies on providing a method for flexibly changing the power level of a pilot symbol to provide a sufficient power gain using total power and a total bandwidth.

Another object of the present invention lies on providing a method for boosting pilot power as high as possible using an optimized power ratio between data symbols.

### [Technical Solution]

To achieve the above objects, the present invention provides a variety of power boosting methods.

In one aspect of the present invention, the above objects can be achieved by providing a method for efficiently boosting pilot symbol power, the method including allocating at least one first resource element (for example, empty RE) for boosting power, at least one second resource element (for example, pilot symbol) for achieving synchronization with a specific channel, and at least one third resource element (for example, data RE) for transmitting data to a predetermined resource region, boosting power of at least one of the second resource element and the third resource element using power allocated to the first resource element, and transmitting information using the predetermined resource region.

The first resource element may be used to measure interference caused by an adjacent base station in a multi-cell environment. Here, the predetermined resource region may include a first symbol region including the at least one first resource element, the at least one second resource element, and the at least one third resource element, and a second symbol region including the at least one third resource element. In addition, the number of the at least one second resource element may be determined according to the number of transmit antennas.

The predetermined resource region may further include a third symbol region including the second resource element and the third resource element. Here, the second resource element included in the first symbol region may be transmitted through a first transmit antenna and a second transmit antenna, and the second resource element included in the third symbol region may be transmitted through a third transmit antenna and a fourth transmit antenna.

The step of boosting the power may include boosting the power taking into consideration the number of the at least one resource elements and a control factor that controls how much power is boosted.

A power ratio (α) between the third resource element included in the first symbol region and the third resource element included in the second symbol region may be calculated using a value (q) obtained by dividing a total number (m) of the resource elements included in the first symbol region by a value obtained by subtracting a sum of the number (e) of the at least one first resource element included in the first symbol region and the number (r) of the at least one second resource element from the total number (m) of the resource elements.

The step of boosting the power may include reallocating all the power allocated to the first resource element to the second resource element.

The step of boosting the power may include reallocating the power allocated to the first resource element to the second resource element and the third resource element at a predetermined ratio.

The number of the at least one first resource element may be determined taking into consideration a total number of the resource elements included in the first symbol region and the number of the at least one second resource element.

The step of boosting the power may include reallocating part of the power allocated to the first and second resource elements to the second resource element.

### ADVANTAGEOUS EFFECTS

By applying the embodiments of the present invention to a wireless system, it is possible to achieve the following advantages.

First, it is possible to efficiently boost power allocated to a pilot symbol.

Second, since the power allocated to the pilot symbol is increased, it is possible to increase the cell coverage of the base station. It is also possible to increase the performance of channel estimation for data reception.

Third, since the power level of the pilot symbol is flexibly applied, it is possible to achieve a sufficient power gain using total power and a total bandwidth.

Fourth, since the optimized power ratio between data symbols is used, it is possible to boost the pilot power as high as possible.

Fifth, network components can efficiently transmit and receive data using methods suggested in the embodiments of the present invention.

### DESCRIPTION OF DRAWINGS

The accompanying drawings, which are included to provide a further understanding of the invention, illustrate embodiments of the invention and together with the description serve to explain the principle of the invention.

In the drawings:

FIG. 1 illustrates an example method for mapping downlink reference signals.

FIG. 2 illustrates an example method for mapping downlink pilot symbols and empty REs according to another embodiment of the present invention.

FIG. 3 illustrates an example method for mapping downlink pilot symbols and empty REs according to another embodiment of the present invention.

FIG. 4 illustrates an example method for mapping downlink pilot symbols and empty REs according to another embodiment of the present invention.

FIG. 5 illustrates an example method for mapping downlink pilot symbols and empty REs according to another embodiment of the present invention.

FIG. 6 illustrates a method for boosting power according to another embodiment of the present invention.

### BEST MODE

The present invention relates to a wireless access system.

The following embodiments are provided by combining components and features of the present invention in specific forms. The components or features of the present invention can be considered optional if not explicitly stated otherwise. The components or features may be implemented without being combined with other components or features. The embodiments of the present invention may also be provided by combining some of the components and/or features. The order of the operations described below in the embodiments of the present invention may be changed. Some components or features of one embodiment may be included in another embodiment or may be replaced with corresponding components or features of another embodiment.

Procedures or steps which may obscure the subject matter of the present invention and procedures or steps which can be understood by those skilled in the art will not be described in the following description of the present invention taken in conjunction with the accompanying drawings.

The embodiments of the present invention will be described focusing mainly on the data communication relationship between a Mobile Station (MS) and a Base Station (BS). The BS is a terminal node in a network which performs communication directly with the terminal. Specific operations which will be described as being performed by the BS may also be performed by an upper node as needed.

That is, it will be apparent to those skilled in the art that the BS or any other network node may perform various operations for communication with MSs in a network including a number of network nodes including BSs. The term “base station (BS)” may be replaced with another term such as “fixed station”, “Node B”, “eNode B (eNB)”, or “access point”. The term “mobile station (MS)” may also be replaced with another term such as “user equipment (UE)”, “mobile subscriber station (MSS)”, “terminal”, or “mobile terminal”.

In addition, the term “transmitting end” refers to a node that transmits a data or audio service and “receiving end” refers to a node that receives a data or audio service. Accordingly, in uplink, the MS may be a transmitting end while the BS may be a receiving end. Similarly, in downlink, the MS may be a receiving end while the BS may be a transmitting end.

A Personal Digital Assistant (PDA), a cellular phone, a Personal Communication Service (PCS) phone, a Global System for Mobile (GSM) phone, a Wideband CDMA (WCDMA) phone, a Mobile Broadband System (MBS) phone, or the like may be used as the MS of the present invention.

The embodiments of the present invention can be implemented by a variety of means. For example, the embodiments can be implemented by hardware, firmware, software, or any combination thereof.

In the case where the present invention is implemented by hardware, methods according to the embodiments of the present invention may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or the like.

In the case where the present invention is implemented by firmware or software, methods according to the embodiments of the present invention may be implemented in the form of modules, processes, functions, or the like which perform the features or operations described below. Software code can be stored in a memory unit so as to be executed by a processor. The memory unit may be located inside or outside the processor and can communicate data with the processor through a variety of known means.

The embodiments of the present invention can be supported by standard documents of at least one of the IEEE 802 system, the 3GPP system, the 3GPP LTE system, and the 3GPP2 system which are wireless access systems. That is, steps or portions that are not described in the embodiments of the present invention for the sake of clearly describing the spirit of the present invention can be supported by the standard documents. For all terms used in this disclosure, reference can be made to the standard documents.

Specific terms used in the following description are provided for better understanding of the present invention and can be replaced with other terms without departing from the spirit of the present invention.

In the embodiments of the present invention, the term “pilot symbol” can be used interchangeably with other various terms. For example, the term “pilot symbol” can be used interchangeably with the term “Reference Signal (RS)” or “pilot signal”. The pilot symbol may indicate any signal that serves to achieve synchronization with a Base Station (BS) and to obtain information of the BS.

Specific resource regions are described in the embodiments of the present invention. For example, a resource region can be used to transmit downlink or uplink data and reference signals (or pilot signals). One Resource Block (RB) may include one or more Resource Elements (REs). The size of an RB and the size of an RE may vary according to user requirements or channel environments.

One RB used in the embodiments of the present invention may include 6 subcarriers and 14 Orthogonal Frequency Division Multiplexing (OFDM) symbols. Here, one RE may include one subcarrier and one OFDM symbol.

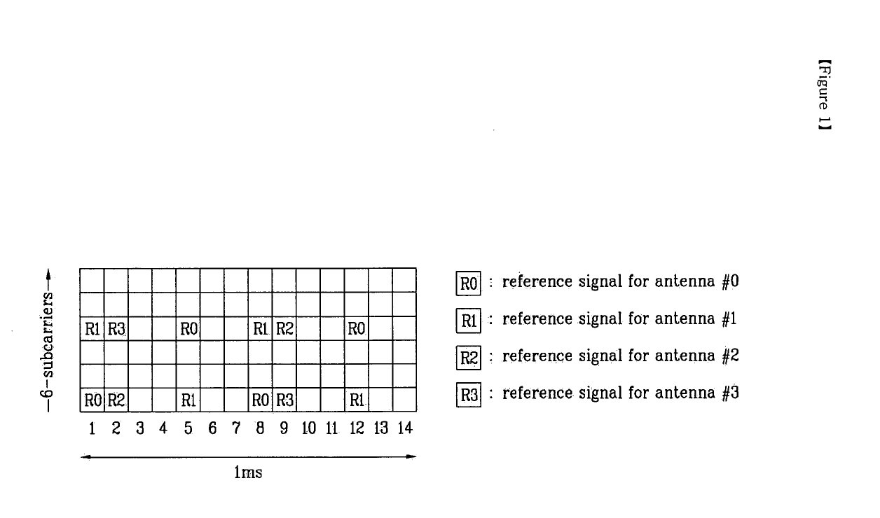

FIG. 1 illustrates an example method for mapping downlink reference signals.

Specifically, FIG. 1 illustrates a mapping method when four transmit antennas are used in a multiple antenna system. In the example of FIG. 1, it is assumed that the total data power of an OFDM symbol which includes no Reference Signal (RS) is E_{B} and the total data power of an OFDM symbol which includes a Reference Signal (RS) is E_{A}. In the following description, an OFDM symbol which includes no RS will also be referred to as a “non-RS OFDM symbol” and an OFDM symbol which includes an RS will also be referred to as an “RS OFDM symbol”. Here, the relationship between E_{A} and E_{B} is expressed as follows.

E_{A}=(1−η_{RS})E_{B} [Formula 1]

In Formula 1, η_{RS} represents a ratio of the total RS power to the total power of an RS OFDM symbol. Let (P_{B, k} N_{B, k}) be a pair of the Energy Per Resource Element (EPRE) and the number of allocated subcarriers of data REs in a non-RS OFDM symbol for a kth user and let (P_{A, k} N_{A, k}) be a pair of the EPRE and the number of allocated subcarriers of data REs in an RS OFDM symbol. That is, N_{B, k} represents the number of REs to which data is allocated in a non-RS OFDM symbol and N_{A, k} represents the number of REs to which data is allocated in an RS OFDM symbol. In addition, N_{RS} represents the number of Reference Signals (RSs) or pilot symbols allocated to an OFDM symbol.

The following is a detailed description of a method for scaling power allocated to data to boost pilot symbol (or RS) power.

A variety of boosting power ratios (α) can be used in a 2Tx system having two transmit antennas and a 4Tx system having four transmit antennas. However, it is assumed in an embodiment of the present invention that a boosting power ratio expressed as in Formula 2 is used.

$$α = \frac{{P}_{A , k}}{{P}_{B , k}} = \frac{3}{2} ( 1 - {η}_{RS} ) \qquad [ Formula 2 ]$$

Two of the six subcarriers of each RS OFDM symbol can be allocated to RS symbols. In this pilot structure,

$${N}_{A , k} = \frac{2}{3} {N}_{B , k} .$$

Accordingly, the RS boosting power ratio (α) is expressed as in Formula 2. In Formula 2, P_{A, k} represents the energy of each data RE for the kth MS or User Equipment (UE) in an RS OFDM symbol and P_{B, k} represents the energy for the kth MS in a non-RS OFDM symbol. Here, k=1, 2, . . . , K, and “K” is the total number of scheduled REs. If the power ratio of Formula 2 is used, it is possible to use the maximum power in both an RS OFDM symbol and a non-RS OFDM symbol.

A boosting power ratio (α) that is used in a 1Tx system having one transmit antenna is expressed as in Formula 3.

$$α = \frac{{P}_{A , k}}{{P}_{B , k}} = \frac{6}{5} ( 1 - {η}_{RS} ) \qquad [ Formula 3 ]$$

One of the six subcarriers of each RS OFDM symbol can be allocated to an RS symbol. In this pilot structure,

$${N}_{A , k} = \frac{5}{6} {N}_{B , k} .$$

Thus, the RS boosting power ratio (α) is expressed as in Formula 3.

Traffic to Pilot (T2P) ratios of other antennas and other OFDM symbols can be obtained based on Formula 2 and 3. The T2P ratio represents a ratio of data RE power to pilot RE power.

The following Table 1 illustrates a T2P ratio in a 1Tx system having one transmit antenna.

TABLE 1

| | i ε {1, 5, 8, 12} | i ε {2, 3, 4, 6, 7, 9, 10, 11, 13, 14} |
|---|---|---|
| t ε {0} | $\frac{6}{5} ( 1 - {η}_{RS} ) \frac{{P}_{B , k}}{{P}_{RS}}$ | $\frac{{P}_{B , k}}{{P}_{RS}}$ |

In Table 1, “i” represents an OFDM symbol index, where i=1, 2, . . . , 14, and “t” represents a transmit antenna index. Here, the value of “i” varies according to the RB size and the RB size may vary according to user requirements or communication environments.

As shown in Table 1, an RS is included in OFDM symbols with indices 1, 5, 8, and 12 in a specific RB, where the T2P ratio is

$$\frac{6}{5} ( 1 - {η}_{RS} ) \frac{{P}_{B , k}}{{P}_{RS}} .$$

The following Table 2 illustrates T2P ratios in a 2Tx system having two transmit antennas.

TABLE 2

| | i ε {1, 5, 8, 12} | i ε {2, 3, 4, 6, 7, 9, 10, 11, 13, 14} |
|---|---|---|
| t ε {0, 1} | $\frac{3}{2} ( 1 - {η}_{RS} ) \frac{{P}_{B , k}}{{P}_{RS}}$ | $\frac{{P}_{B , k}}{{P}_{RS}}$ |

As shown in Table 2, OFDM symbols with indices 1, 5, 8, and 12 include an RS and the remaining symbol indices represent OFDM symbols that carry data only. The T2P ratios of the OFDM symbols with indices 1, 5, 8, and 12 and the remaining OFDM symbols are shown in Table 2.

The following Table 3 illustrates T2P ratios in a 4Tx system having four transmit antennas.

TABLE 3

| | i ε {1, 2, 5, 8, 9, 12} | i ε {3, 4, 6, 7, 10, 11, 13, 14} |
|---|---|---|
| t ε {0, 1, 2, 3} | $\frac{3}{2} ( 1 - {η}_{RS} ) \frac{{P}_{B , k}}{{P}_{RS}}$ | $\frac{{P}_{B , k}}{{P}_{RS}}$ |

As shown in Table 3, OFDM symbols with indices 1, 2, 5, 8, 9, and 12 include an RS and the remaining symbol indices represent OFDM symbols that carry data only. The T2P ratios of the OFDM symbols with indices 1, 2, 5, 8, 9, and 12 and the remaining OFDM symbols are shown in Table 3.

The following Table 4 illustrates an example wherein different T2P ratios are used for antennas and OFDM symbols in a 4Tx system having four transmit antennas.

TABLE 4

| | i ε {1, 5, 8, 12} | i ε {2, 9} | i ε {3, 4, 6, 7, 10, 11, 13, 14} |
|---|---|---|---|
| t ε {0, 1} | $\frac{3}{2} ( 1 - {η}_{RS} ) \frac{{P}_{B , k}}{{P}_{RS}}$ | $\frac{3}{2} \frac{{P}_{B , k}}{{P}_{RS}}$ | $\frac{{P}_{B , k}}{{P}_{RS}}$ |
| t ε {2, 3} | $\frac{3}{2} \frac{{P}_{B , k}}{{P}_{RS}}$ | $\frac{3}{2} ( 1 - {η}_{RS} ) \frac{{P}_{B , k}}{{P}_{RS}}$ | $\frac{{P}_{B , k}}{{P}_{RS}}$ |

It can be seen from Table 4 that a first transmit antenna and a second transmit antenna (t=0, 1) use the same T2P ratios and a third transmit antenna and a fourth transmit antenna (t=2, 3) use the same T2P ratios. In addition, each of the antennas which operate in pairs uses a different T2P ratio for each OFDM symbol, thereby achieving efficient RS pilot power boosting.

As shown in Table 4, RS symbols for the first and second transmit antennas are included in OFDM symbols with indices 1, 5, 8, and 12 and RS symbols for the third and fourth transmit antennas are included in OFDM symbols with indices 2 and 9. Accordingly, using Table 4, it is possible to obtain the ratio of pilot symbol power to data power in each OFDM symbol for each transmit antenna.

The following is a detailed description of a method for boosting pilot symbol power using an empty RE.

In the embodiments of the present invention, empty REs can be used to boost power of an RS symbol or to measure the level of multi-cell interference. The number and position of empty REs may vary according to user requirements or communication environments.

In the embodiments of the present invention, empty REs can be allocated on an m-subcarrier basis when it is assumed that each RB includes the same number of (N_{empty}) empty REs. For example, r REs among m REs may be the N_{empty} REs. These empty REs can be used for on-off operations in an RS OFDM symbol. However, it is difficult to use empty REs in an OFDM symbol that includes no RS and includes data REs only.

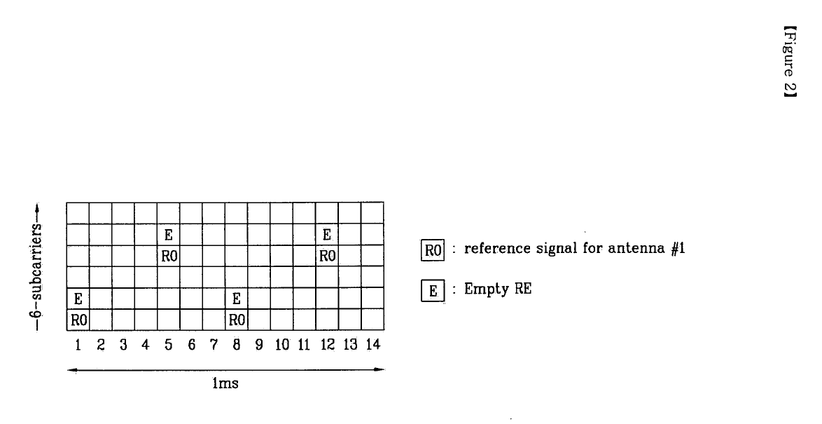

FIG. 2 illustrates an example method for mapping downlink pilot symbols and empty REs according to another embodiment of the present invention.

Specifically, FIG. 2 illustrates a mapping method in the case where an empty RE is used in each OFDM symbol including a pilot symbol for the first transmit antenna (antenna #0) when the number of transmit antennas is 1. In this method, pilot symbols are allocated to OFDM symbols with indices 1, 5, 8, and 12 and empty REs for pilot symbol boosting are allocated one by one to the OFDM symbols as shown in FIG. 2. Of course, the number and position of allocated empty REs may be changed.

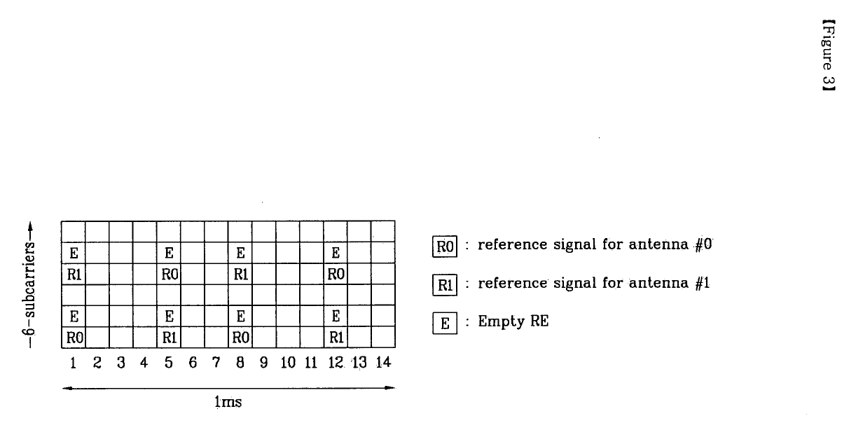

FIG. 3 illustrates an example method for mapping downlink pilot symbols and empty REs according to another embodiment of the present invention.

Specifically, FIG. 3 illustrates a mapping method in the case where empty REs are used in each OFDM symbol including pilot symbols (R0 and R1) for the first transmit antenna (antenna #0) and the second transmit antenna (antenna #1) when the number of transmit antennas is 2. In the method of FIG. 3, pilot symbols for the first and second transmit antennas are allocated to the same OFDM symbol and empty REs can be allocated to the same OFDM symbol for boosting of the pilot symbols.

Unlike the method of FIG. 3, the pilot symbol (R0) for the first transmit antenna and the pilot symbol (R1) for the second transmit antenna can be allocated to different OFDM symbols. The number of empty REs for each pilot symbol may vary according to user requirements or channel environments.

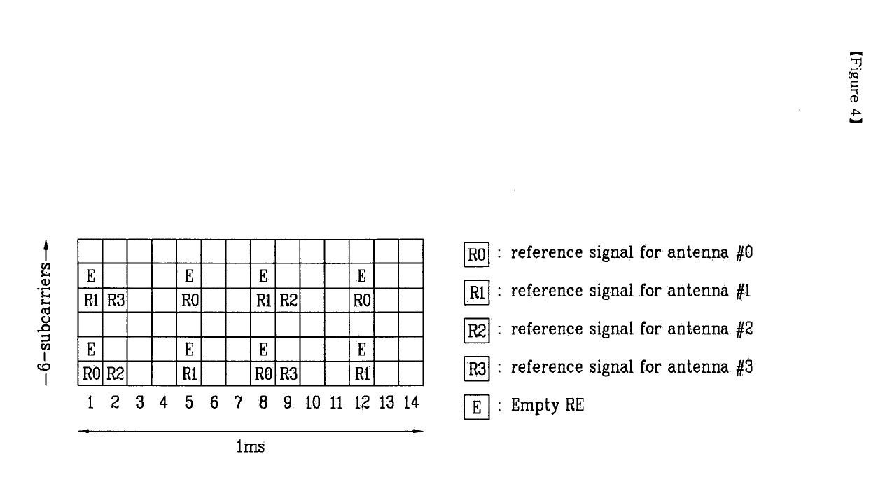

FIG. 4 illustrates an example method for mapping downlink pilot symbols and empty REs according to another embodiment of the present invention.

In the method of FIG. 4, empty REs are used in each OFDM symbol including pilot symbols (R0 and R1) for the first transmit antenna and the second transmit antenna and no empty REs are used in each OFDM symbol including pilot symbols (R2 and R3) for the third transmit antenna (antenna #2) and the fourth transmit antenna (antenna #3).

Of course, no empty REs may be used in each OFDM symbol including pilot symbols for the first transmit antenna and the second transmit antenna while empty REs may be used in each OFDM symbol including pilot symbols for the third transmit antenna and the fourth transmit antenna. The number of allocated empty REs may vary according to user requirements or channel environments.

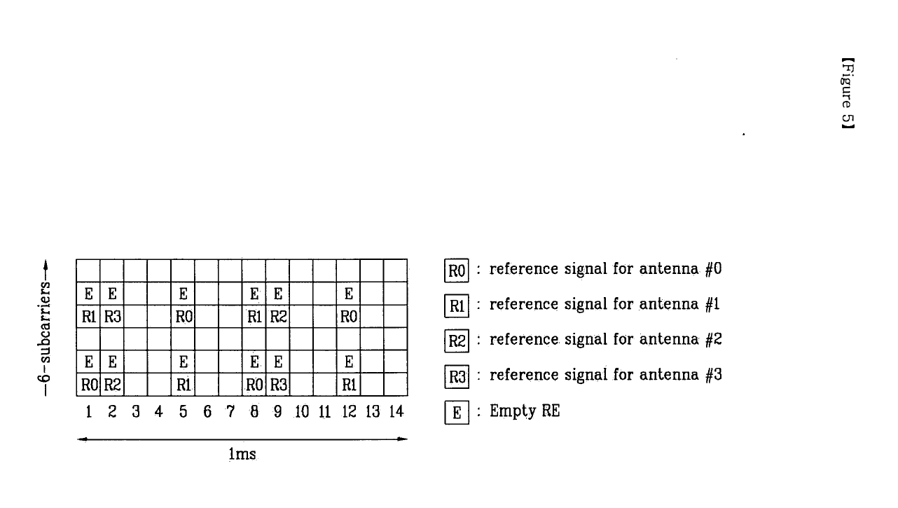

FIG. 5 illustrates an example method for mapping downlink pilot symbols and empty REs according to another embodiment of the present invention.

The method of FIG. 5 is basically similar to that of FIG. 4. However, in the method of FIG. 5, an empty RE is used for every pilot symbol. That is, empty REs are allocated to each OFDM symbol to which pilot symbols are allocated, thereby boosting pilot symbol power.

The following is a description of a method for boosting a pilot symbol illustrated in FIGS. 2 to 5.

A ratio α between data power of an OFDM symbol including a pilot symbol and data power of an OFDM symbol including no pilot symbol in a 2Tx system having two transmit antennas and a 4Tx system having four transmit antennas is expressed by the following formula.

$$α = \frac{{P}_{A , k}}{{P}_{B , k}} = \frac{6}{4 - {N}_{empty}} ( 1 - {η}_{RS}^{′} ) \qquad [ Formula 4 ]$$

Two of the 6 subcarriers of each RS OFDM symbol can be allocated to RSs. Accordingly,

$${N}_{A , k} = \frac{4}{6} {N}_{B , k} .$$

Specifically, the pilot symbol power boosting ratio α in Formula 4 indicates a ratio of energy (power) of a data RE of an RS OFDM symbol to energy (power) of a data RE of a non-RS OFDM symbol.

In Formula 4, η′_{RS} is a ratio of total power used for a pilot symbol(s), to which extra power generated and stored by an empty RE has been added, to total power of an RS OFDM symbol. Here, whether the extra power generated by the empty RE is all used to boost power of the pilot symbol or is distributed to both the pilot symbol and a data symbol is determined by a value of β as shown in the following Formula 5. Accordingly, power may not be used for a symbol to which an empty RE has been allocated. That is, energy allocated to the empty RE can be stored to be used to boost power of another symbol.

The following Formula 5 represents an example equation for calculating η′_{RS}.

$${η}_{RS}^{′} = {η}_{RS} + \frac{{N}_{empty} \cdot β}{6} , 0 \leq β \leq 1 \qquad [ Formula 5 ]$$

As shown in Formula 5, η′_{RS} can be obtained by adding η_{RS} to the product of β and a value obtained by dividing power allocated to empty REs by the total number of subcarriers included in the symbol.

Energy allocated to empty REs can be reused for various purposes. For example, energy allocated to empty REs can be used to boost RS power, to boost data RE power, and to boost RS and data RE power. The reused power of empty REs can be controlled by a control factor β for energy use.

When β is set to “0” in Formula 5, stored power of empty REs is not used to boost RS power. On the other hand, when β is set to “1”, stored power of empty REs is used to boost RS power only. When β is set to a value between “0” and “1”, stored power of empty REs is also allocated to data REs. Thus, it is possible to scale data RE power to a desired value.

Therefore, even when an empty RE is included in an RB, it is possible to keep data RE power constant. In order to simplify the power boosting procedure, the value of β may be fixed depending on the system. In this case, the value of β may also be changed in a dynamic or non-dynamic manner. The value of β can be changed so as to be MS-specific or BS-specific.

Formula 6 represents a pilot symbol power boosting ratio α in a 1Tx system having one transmit antenna.

$$α = \frac{{P}_{A , k}}{{P}_{B , k}} = \frac{6}{5 - {N}_{empty}} ( 1 - {η}_{RS}^{′} ) \qquad [ Formula 6 ]$$

Specifically, Formula 6 represents a ratio α of power of an RS OFDM symbol to power of a non-RS OFDM symbol. One symbol for RS can be allocated to the 6 subcarriers of each RS OFDM symbol. Accordingly,

$${N}_{A , k} = \frac{5}{6} {N}_{B , k} .$$

A ratio of traffic symbol power to pilot symbol power in other antennas and other OFDM symbols can be obtained using Formula 4 to 6. The following Tables 5 to 8 illustrate formulas for calculating an optimized power ratio between data and RS REs according to the number of transmit antennas and OFDM symbol indices in a subframe.

TABLE 5

| | i ε {1, 5, 8, 12} | i ε {2, 3, 4, 6, 7, 9, 10, 11, 13, 14} |
|---|---|---|
| t ε {0} | $\frac{6}{5 - {N}_{empty}} ( 1 - {{η}^{′}}_{RS} ) \frac{{P}_{B , k}}{{P}_{RS}}$ | $\frac{{P}_{B , k}}{{P}_{RS}}$ |

Table 5 illustrates T2P ratios when the number of transmit antennas is 1. In Table 5, “i” represents an OFDM symbol index, where i=1, 2, . . . , 14, and “t” represents a transmit antenna index. Here, the value of “i” varies according to the RB size and the RB size may vary according to user requirements or communication environments.

The following Table 6 illustrates T2P ratios in a 2Tx system having two transmit antennas.

TABLE 6

| | i ε {1, 5, 8, 12} | i ε {2, 3, 4, 6, 7, 9, 10, 11, 13, 14} |
|---|---|---|
| t ε {0, 1} | $\frac{6}{4 - {N}_{empty}} ( 1 - {{η}^{′}}_{RS} ) \frac{{P}_{B , k}}{{P}_{RS}}$ | $\frac{{P}_{B , k}}{{P}_{RS}}$ |

RSs for first and second transmit antennas are allocated to different subcarriers of the same symbol. Specifically, symbols indices 1, 5, 8, and 12 indicate OFDM symbols including RSs and the remaining symbol indices indicate OFDM symbols including data REs only.

In a 4Tx structure having four transmit antennas, different power modes can be applied to the antennas. Specifically, it is possible to employ two options such as a uniform power transmission mode in which the same transmission power is used for each antenna and a non-uniform power transmission mode. The power mode can be changed according to how much power is to be distributed to a specific antenna in the case where power allocated to an empty RE is allocated to a data RE.

For example, the uniform power transmission mode is a mode in which the power of an empty RE is uniformly distributed to each antenna and the non-uniform power transmission mode is a mode in which the power of an empty RE is distributed only to a specific antenna. These two options have their own advantages. Thus, it is preferable to use one or more of the two options according to channel environments and the system.

The following Table 7 illustrates T2P ratios of the uniform power transmission mode in a 4Tx system having four transmit antennas.

TABLE 7

| | i ε {1, 2, 5, 8, 9, 12} | i ε {3, 4, 6, 7, 10, 11, 13, 14} |
|---|---|---|
| t ε {0, 1, 2, 3} | $\frac{6}{4 - {N}_{empty}} ( 1 - {{η}^{′}}_{RS} ) \frac{{P}_{B , k}}{{P}_{RS}}$ | $\frac{{P}_{B , k}}{{P}_{RS}}$ |

Table 7 is applied to the uniform power transmission mode. From Table 7, it can be seen that an RS of each transmit antenna is allocated to the same OFDM symbol. Here, power allocated to an empty RE can be uniformly allocated to each RS.

The following Table 8 illustrates T2P ratios of the non-uniform power transmission mode in a 4Tx system having four transmit antennas.

TABLE 8

| | i ε {1, 5, 8, 12} | i ε {2, 9} | i ε {3, 4, 6, 7, 10, 11, 13, 14} |
|---|---|---|---|
| t ε {0, 1} | $\frac{6}{4 - {N}_{empty}} ( 1 - {{η}^{′}}_{RS} ) \frac{{P}_{B , k}}{{P}_{RS}}$ | $\frac{6}{4 - {N}_{empty}} \frac{{P}_{B , k}}{{P}_{RS}}$ | $\frac{{P}_{B , k}}{{P}_{RS}}$ |
| t ε {2, 3} | $\frac{6}{4 - {N}_{empty}} \frac{{P}_{B , k}}{{P}_{RS}}$ | $\frac{6}{4 - {N}_{empty}} ( 1 - {{η}^{′}}_{RS} ) \frac{{P}_{B , k}}{{P}_{RS}}$ | $\frac{{P}_{B , k}}{{P}_{RS}}$ |

Specifically, Table 8 illustrates an example where energy allocated to an empty RE is allocated to an RS. As can be seen from Table 8, RSs for first and second transmit antennas (t=0, 1) are included in OFDM symbols with indices 1, 5, 8, and 12 and RSs for third and fourth transmit antennas (t=2, 3) are included in OFDM symbols with indices 2 and 9.

Generally, a ratio α between power of two data REs (P_{B, k} and P_{A, k}) can be signaled to a Mobile Station (MS) or UE for data symbol decoding. A signaling channel can be used only to indicate the α value. Therefore, it is preferable that the MS and the BS (or Node-B) already know a set of predefined α values. If the MS and the BS already know the set of α values, only indices corresponding to the α values can be transmitted, thereby simplifying data transmission.

Although Tables 7 and 8 illustrate an example wherein RSs are included in 6 OFDM symbols, the number and positions of OFDM symbols to which RSs are allocated in one RB can be differently applied according to channel environments or user requirements.

The following Table 9 illustrates an example set of predefined η_{RS} values in the case where no empty RE is used.

| Index | η_{RS} |
|---|---|
| 00 | ⅙ |
| 01 | ⅓ |
| 10 | ½ |
| 11 | ⅔ |

As shown in Table 9, respective indices are allocated to η_{RS} values and thus the BS can simply notify the MS of power boosting values using only the indices instead of the η_{RS} values.

The following Table 10 summarizes formulas for calculating the α values according to the number of antennas and whether the transmission mode is the uniform power transmission mode (Mode-1) or the non-uniform power transmission mode (Mode-2) in the case where no empty RE is used.

TABLE 10

| | 1Tₓ | 2Tₓ | 4Tₓ | |
|---|---|---|---|---|
| | α | α | α₁ | α₂ |
| Mode-1 | $\frac{6}{5} ( 1 - {η}_{RS} )$ | $\frac{3}{2} ( 1 - {η}_{RS} )$ | $\frac{3}{2} ( 1 - {η}_{RS} )$ | $\frac{3}{2}$ |
| Mode-2 | $\frac{6}{5} ( 1 - {η}_{RS} )$ | $\frac{3}{2} ( 1 - {η}_{RS} )$ | $\frac{3}{2} ( 1 - {η}_{RS} )$ | $\frac{3}{2} ( 1 - {η}_{RS} )$ |

Specifically, Table 10 illustrates power ratios in the uniform power transmission mode (Mode-1) and the non-uniform power transmission mode (Mode-2) in the 4Tx system including four transmit antennas. The power ratios of the two types of REs in the uniform power transmission mode can be classified into two types of α values according to an OFDM symbol including RSs for antenna ports {0, 1} or antenna ports {2, 3}.

For example, if the OFDM symbols include RSs for the antenna ports {0, 1}, αₗ represents a power ratio between a data RE in an OFDM symbol including RSs for the antenna ports {0, 1} and a data RE in an OFDM symbol including no RS. However, if the OFDM symbols include RSs for the antenna ports {2, 3}, α₁ represents a power ratio between a data RE in an OFDM symbol including RSs for the antenna ports {2, 3} and a data RE in an OFDM symbol including no RS. On the other hand, α₂ represents a power ratio between data REs for the remaining antenna ports.

The following Table 11 illustrates α values, RS boosting ratios, and the number of antennas according to the power mode in the case where no empty RE is used.

TABLE 11

| | | |
|---|---|---|
| 1Tₓ | 2Tₓ | 4Tₓ |

| index | α | α | α₁ | α₂ |
|---|---|---|---|---|
| 000 | 1 | 5/4 | 5/4 | 3/2 |
| 001 | ⅘ | 1 | 1 | 3/2 |
| 010 | ⅗ | ¾ | ¾ | 3/2 |
| 011 | ⅖ | ½ | ½ | 3/2 |
| 100 | 1 | 5/4 | 5/4 | 5/4 |
| 101 | ⅘ | 1 | 1 | 1 |
| 110 | ⅗ | ¾ | ¾ | ¾ |
| 111 | ⅖ | ½ | ½ | ½ |

Table 11 is a representation of Tables 9 and 10 using a 3-bit bitmap. Specifically, the BS (or Node-B) can notify the MS of the current power ratio using 3 bits. In Table 11, the MSB of the 3 bits represents the power mode and the remaining two bits represent the RS boosting ratio η_{RS}. For example, the MSB indicates the uniform power transmission mode if the MSB is “0” and indicates the non-uniform power transmission mode if the MSB is “1”. When the transmission mode is determined, the BS can notify the MS of the boosting ratio according to the transmission mode using the remaining two bits.

The following Table 12 represents a set of predefined η′_{RS} values in the case where an empty RE is used.

| | | η′_{RS} (β = 0) | η′_{RS} (β = 1) |
|---|---|---|---|
| Index | η_{RS} | N _{empty} = 1 | N _{empty} = 1 |
| 00 | ⅙ | ⅙ | ⅓ |
| 01 | ⅓ | ⅓ | ½ |
| 10 | ½ | ½ | ⅔ |
| 11 | ⅔ | ⅔ | ⅚ |

In Table 12, the value of η′_{RS} can be obtained using Formula 5. In Formula 5, the β value may be dynamically changed according to time. The β value can also be set to be fixed according to channel environments or user requirements. If the β value in Table 12 is “0”, this indicates that no empty RE is used and, if the β value is “1”, this indicates that an empty RE is used.

The following Table 13 summarizes formulas for calculating the α values according to the number of antennas and whether the transmission mode is the uniform power transmission mode (Mode-1) or the non-uniform power transmission mode (Mode-2) in the case where an empty RE is used.

TABLE 13

| | 1Tₓ | 2Tₓ | 4Tₓ | |
|---|---|---|---|---|
| | α | α | α₁ | α₂ |
| Mode-1 | $\frac{6}{5 - {N}_{empty}} ( 1 - {{η}^{′}}_{RS} )$ | $\frac{6}{4 - {N}_{empty}} ( 1 - {{η}^{′}}_{RS} )$ | $\frac{6}{4 - {N}_{empty}} ( 1 - {{η}^{′}}_{RS} )$ | $\frac{6}{4 - {N}_{empty}}$ |
| Mode-2 | $\frac{6}{5 - {N}_{empty}} ( 1 - {{η}^{′}}_{RS} )$ | $\frac{6}{4 - {N}_{empty}} ( 1 - {{η}^{′}}_{RS} )$ | $\frac{6}{4 - {N}_{empty}} ( 1 - {{η}^{′}}_{RS} )$ | $\frac{6}{4 - {N}_{empty}} ( 1 - {{η}^{′}}_{RS} )$ |

The α value can be obtained according to the number of antennas and the transmission mode with reference to the formulas illustrated in Table 13. Tables 12 and 13 can be summarized in one table, similar to Table 11. Specifically, using a 3-bit bitmap, it is possible to efficiently represent the α value according to the number of transmit antennas and the transmission mode.

In the embodiments of the present invention, empty REs can be used at a predetermined ratio in an OFDM symbol in which an RS RE is used. The number of empty REs used can be changed according to an OFDM symbol index and/or an RB index. Empty REs may be used only for a specific cell or a specific MS or User Equipment (UE). The ratio of use of empty REs can be changed according to time and/or frequency in a specific cell.

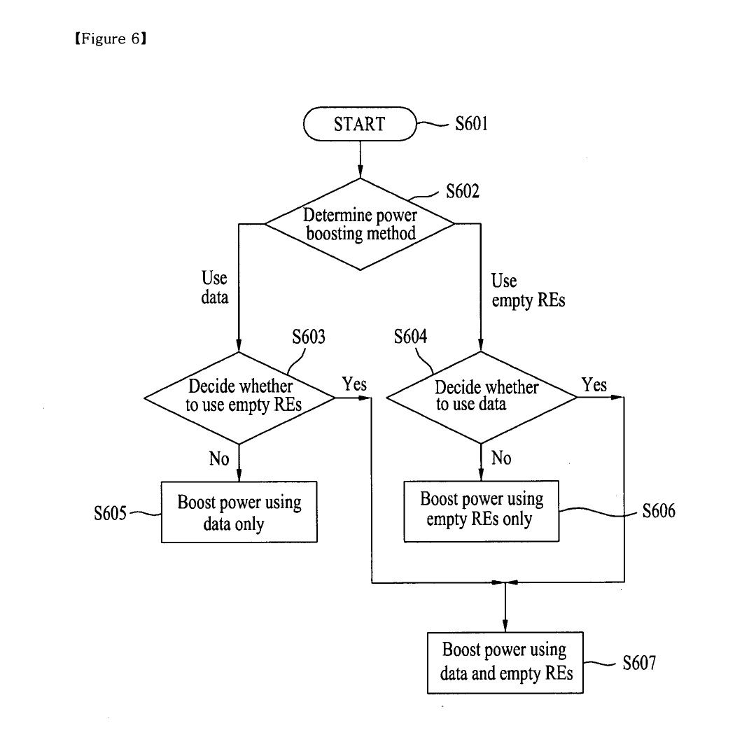

FIG. 6 illustrates a method for boosting power according to another embodiment of the present invention.

A variety of methods for boosting pilot symbol power have been described in the above embodiments. For example, the BS can boost power allocated to a pilot symbol by scaling power allocated to data REs or can boost pilot symbol power using empty REs.

As shown in FIG. 6, first, the BS determines a power boosting method for use (S601, S602).

The BS may first decide to use power allocated to data REs in order to boost pilot symbol power. Here, the BS may again decide whether or not to use empty REs (S603).

In the case where the BS has decided not to use empty REs, the BS can boost pilot symbol power using data REs only (S605).

At step S602, the BS may first decide to boost pilot symbol power using empty REs. Here, the BS may again decide whether or not to use data REs (S604).

In the case where the BS has decided not to use data REs, the BS can boost pilot symbol power using empty REs only (S606).

In the case where the BS has decided to use empty REs at step S603, the BS can boost pilot symbol power using data REs and empty REs (S607). In the case where the BS has decided to use data REs at step S604, the BS can boost pilot symbol power using empty REs and data REs (S607).

Which method the BS will use first among the two methods (one using empty REs and the other using data REs) to boost pilot symbol power at step S607 can vary according to user selections or channel environments.

### MODE FOR INVENTION

Various embodiments have been described in the best mode for carrying out the invention.

### INDUSTRIAL APPLICABILITY

Those skilled in the art will appreciate that the present invention may be embodied in other specific forms than those set forth herein without departing from the spirit and essential characteristics of the present invention. The above description is therefore to be construed in all aspects as illustrative and not restrictive. The scope of the invention should be determined by reasonable interpretation of the appended claims and all changes coming within the equivalency range of the invention are intended to be embraced in the scope of the invention. It will be apparent that claims which are not explicitly dependent on each other can be combined to provide an embodiment or new claims can be added through amendment after this application is filed.

1. A method for boosting power for efficient transmission of information, the method comprising:
allocating a first resource element for boosting power, a second resource element for allocating a pilot signal, and a third resource element for transmitting data to a predetermined resource region;
boosting power of at least one of the second resource element and the third resource element using power allocated to the first resource element; and
transmitting the information using the predetermined resource region.

2. The method according to claim 1, wherein the first resource element is used to measure interference caused by an adjacent base station in a multi-cell environment.

3. The method according to claim 1 or 2, wherein the predetermined resource region includes:
a first symbol region including the first resource element, the second resource element, the third resource element; and
a second symbol region including the third resource element.

4. The method according to claim 3, wherein a number of the second resource element is determined according to the number of transmit antennas.

5. The method according to claim 3, wherein the predetermined resource region further includes a third symbol region including the second resource element and the third resource element.

6. The method according to claim 5, wherein the second resource element included in the first symbol region is transmitted through a first transmit antenna and a second transmit antenna, and
the second resource element included in the third symbol region is transmitted through a third transmit antenna and a fourth transmit antenna.

7. The method according to claim 3, wherein the step of boosting the power includes boosting the power of the second resource element taking into consideration the number of the first resource elements and a control factor that controls how much power is boosted.

8. The method according to claim 3, wherein a power ratio (α) between the third resource element included in the first symbol region and the third resource element included in the second symbol region is calculated using a value (q) obtained by dividing a total number (m) of the resource elements included in the first symbol region by a value obtained by subtracting a sum of a number (e) of the first resource element and a number (r) of the second resource element included in the first symbol region from the total number (m) of the resource elements.

9. The method according to claim 3, wherein the step of boosting the power includes reallocating all the power allocated to the first resource element to the second resource element.

10. The method according to claim 3, wherein the step of boosting the power includes reallocating the power allocated to the first resource element to the second resource element and the third resource element at a predetermined ratio.

11. The method according to claim 3, wherein a number of the first resource element is determined taking into consideration a total number of the resource elements and a number of the second resource element included in the first symbol region.

12. The method according to claim 3, wherein the step of boosting the power includes reallocating part of the power allocated to the first and third resource elements to the second resource element.
